(19) United States
(12) Patent Application Publication
(10) Pub. No.: US 2021/0129984 A1
(43) Pub. Date: May 6, 2021

(54) UNMANNED AERIAL VEHICLE

(71) Applicant: Nidec Corporation, Kyoto (JP)

(72) Inventor: Masashi TAKAO, Kyoto (JP)

(21) Appl. No.: 16/475,729

(22) PCT Filed: Jan. 30, 2018
(86) PCT No.: PCT/JP2018/002856

§ 371 Date: Jul. 3, 2019

Related U.S. Application Data
(60) Provisional application No. 62/451,892, filed on Jan. 30, 2017.

(51) Int. Cl. B64C 39/02; B64D 27/24; B64D 47/08; B60L 50/60

(52) U.S. Cl. CPC B64C 39/024; B64D 27/24; B64D 47/08; B64C 2201/108; B60L 2200/10; B64C 2201/027; B64C 2201/042; B60L 50/60

(57) ABSTRACT

An unmanned aerial vehicle in which a circle drawn by a tip of a main propeller and a circle drawn by a tips of each of a plurality of auxiliary propellers axially overlap at least partially, a rotational direction of the plurality of auxiliary propellers is opposite to a rotational direction of the main propeller when viewed from one axial side of a main shaft, and a torque acting on a body from the main propeller when the body is hovering in the air is equal or substantially equal to a sum of torque acting on the body from the plurality of auxiliary propellers.

### CROSS REFERENCE TO RELATED APPLICATIONS

This is the U.S. national stage of PCT Application No. PCT/JP2018/002856, filed on Jan. 30, 2018, and priority under U.S.C. § 119(a) and 35 U.S.C. § 365(b) is claimed from U.S. Provisional Patent Application No. 62/451,892, filed Jan. 30, 2017; the entire disclosures of each application are incorporated herein by reference.

### FIELD OF THE INVENTION

The present disclosure relates to an unmanned aerial vehicle that includes a plurality of propellers.

### BACKGROUND

A conventional unmanned aerial vehicle is disclosed in Japanese Laid-Open Patent Publication No. 2016-88121. This aerial vehicle has a base on which an observation unit is attached, a plurality of thrusters, an actuator, an inertial measurement unit, and a control unit. The plurality of thrusters generate lift. The actuator makes the direction of propulsion generated by the thruster variable relative to the base. The inertial measurement unit detects the attitude of the base relative to the ground surface. The control unit controls the thrusters and the actuator based on the attitude of the base detected by the inertial measurement unit. Then, the aerial vehicle flies at any attitude relative to the ground surface due to a combination of the propulsion of each of the thrusters and the direction of the propulsion. The aerial vehicle with such a configuration flies unmanned. The thruster has a propeller unit and a motor unit that rotates the propeller unit.

A conventional unmanned aerial vehicle rotates the propeller unit at high speed in order to obtain sufficient lift. Therefore, there is a problem of loud noise of the propeller unit. In particular, when used indoors or in an unmanned aerial vehicle equipped with an audio device, the noise of the propeller unit may cause an operational problem.

### SUMMARY

An example embodiment of an unmanned aerial vehicle of the present disclosure includes a body, a main shaft, a main propeller, a plurality of auxiliary shafts, a plurality of auxiliary propellers, and a plurality of drivers. The main shaft extends axially from the body. The main propeller is connected to the main shaft. The plurality of auxiliary shafts extend axially from the body. The plurality of auxiliary propellers are connected to the plurality of auxiliary shafts respectively. The plurality of drivers drive the main propeller and the plurality of auxiliary propellers. A circle drawn by a tip of the main propeller and a circle drawn by tips of each of the plurality of auxiliary propellers axially overlap at least partially. The rotational direction of the plurality of auxiliary propellers is opposite to the rotational direction of the main propeller, when viewed from one axial side of the main shaft. A torque acting on the body from the main propeller when the body portion is hovering in the air is equal or substantially equal to the sum of the torque acting on the body portion from the plurality of auxiliary propellers.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of an unmanned aerial vehicle according to an example embodiment of the present disclosure as viewed from below.

FIG. 2 is a schematic plan view of the unmanned aerial vehicle shown in FIG. 1.

FIG. 3 is a schematic side view of the unmanned aerial vehicle shown in FIG. 1.

FIG. 4 is an enlarged sectional view of a main propeller and a main motor according to an example embodiment of the present disclosure.

FIG. 5 is an enlarged sectional view of an auxiliary propeller and an auxiliary motor according to an example embodiment of the present disclosure.

FIG. 6 is a schematic side view of another example embodiment of the unmanned aerial vehicle according to the present disclosure.

FIG. 7 is a schematic view of the auxiliary propeller and the auxiliary motor.

FIG. 8 is a schematic side view of yet another example embodiment of the unmanned aerial vehicle according to the present disclosure.

FIG. 9 is a schematic plan view of yet another example embodiment of the unmanned aerial vehicle according to the present disclosure.

FIG. 10 is a schematic side view of the unmanned aerial vehicle shown in FIG. 9.

FIG. 11 is an enlarged sectional view of the main propeller and the main motor.

FIG. 12 is a schematic side view of yet another example embodiment of the unmanned aerial vehicle according to the present disclosure.

FIG. 13 is an enlarged sectional view of the main propeller and the main motor of the unmanned aerial vehicle shown in FIG. 12.

FIG. 14 is a plan view of yet another example embodiment of the unmanned aerial vehicle according to the present disclosure.

FIG. 15 is a schematic side view of the unmanned aerial vehicle shown in FIG. 14.

FIG. 16 is a schematic side view of yet another example embodiment of the unmanned aerial vehicle according to the present disclosure.

FIG. 17 is a schematic side view of yet another example embodiment of the unmanned aerial vehicle according to the present disclosure.

### DETAILED DESCRIPTION

Hereinafter, example embodiments of the present disclosure will be described in detail with reference to the drawings. In this description, a direction parallel to a central axis Ax of an unmanned aerial vehicle Dr1 is called an “axial direction/axial/axially”, a direction orthogonal to the central axis Ax of the unmanned aerial vehicle Dr1 is called a “radial direction/radial/radially”, and a direction along the arc centering on the central axis of the unmanned aerial vehicle Dr1 is called a “circumferential direction/circumferential/circumferentially”. Also as for unmanned aerial vehicles other than the unmanned aerial vehicle Dr1, similarly, directions corresponding to the axial direction, the radial direction, and the circumferential direction of the unmanned aerial vehicle Dr1 are simply called an “axial direction/axial/axially”, a “radial direction/radial/radially”, and a “circumferential direction/circumferential/circumferentially”, respectively.

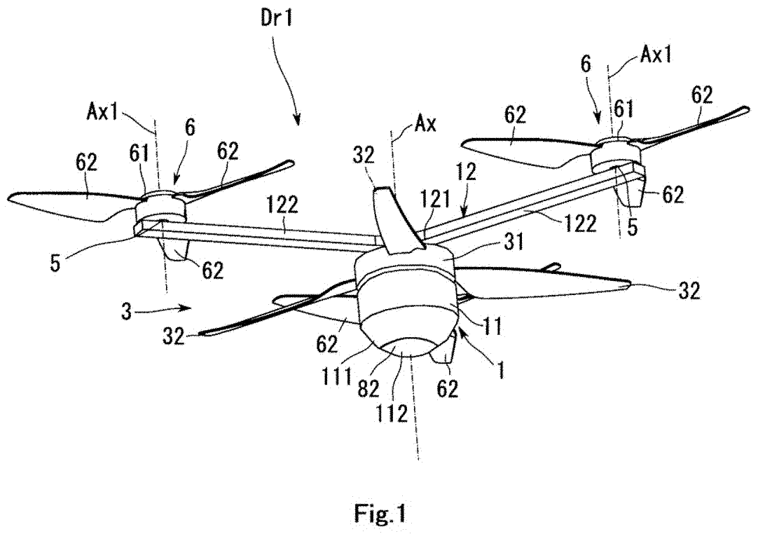

In this description, the shape and positional relationship of each portion of the unmanned aerial vehicle Dr1 will be explained with the upward direction in FIG. 1 as “upward” and the downward direction in FIG. 1 as “downward”. Note that these directions are merely names used simply for explanation, and do not limit the positional relationship and direction in the flight state of the unmanned aerial vehicle Dr1.

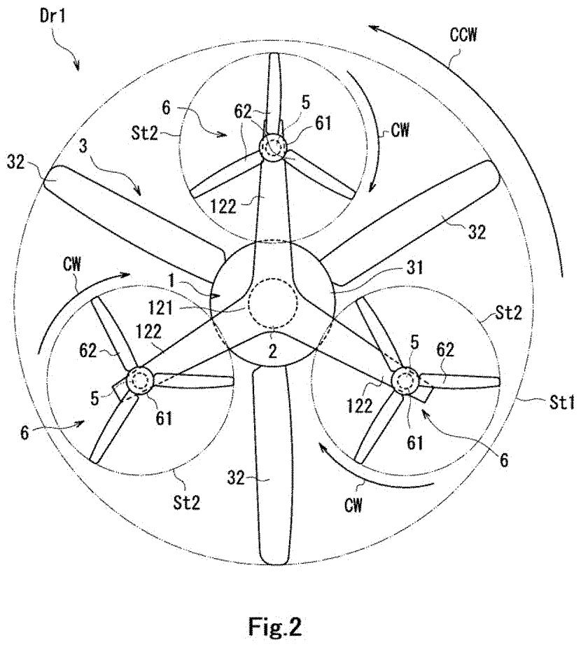

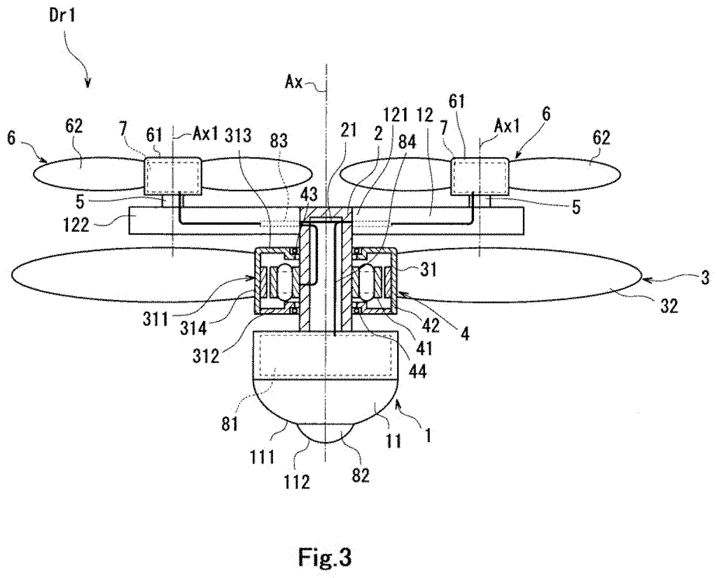

The unmanned aerial vehicle of an example embodiment of the present disclosure will be described below. FIG. 1 is a perspective view of an unmanned aerial vehicle according to the present example embodiment as viewed from below. FIG. 2 is a schematic plan view of the unmanned aerial vehicle shown in FIG. 1. FIG. 3 is a schematic side view of the unmanned aerial vehicle shown in FIG. 1. In order to facilitate understanding, FIG. 3 indicates a part of cross section.

As shown in FIGS. 1 to 3, the unmanned aerial vehicle Dr1 includes a body portion 1, a main shaft 2, a main propeller 3, a main motor 4, three auxiliary shafts 5, three auxiliary propellers 6, three auxiliary motors 7, a battery 81, a camera 82, and a circuit board 83. In the unmanned aerial vehicle Dr1, the main shaft 2 and the three auxiliary shafts 5 extend axially from the body portion 1. Then, the main propeller 3 connected to the main shaft 2 and the auxiliary propeller 6 connected to each of the three auxiliary shafts 5 are rotated by the main motor 4 and the three auxiliary motors 7. The rotation of the main propeller and the three auxiliary propellers 6 generates an air flow axially downward. The unmanned aerial vehicle Dr1 is lifted by air flow generated by the rotation of the main propeller 3 and the three auxiliary propellers 6, and floats in the air. Although the unmanned aerial vehicle Dr1 includes the three auxiliary propellers 6, the number of the auxiliary propellers is not limited to three, and it may be two or be four or more. Although the number is not restricted as long as attitude control, movement control, and the like can be easily performed, at least a plurality of them are included. The rotation radius of the main propeller 3 with respect to the rotation axis is larger than the rotation radius of the auxiliary propeller 6 with respect to the rotation axis. That is, the main propeller 3 is a larger propeller than the auxiliary propeller 6.

The body portion 1 includes a main body portion 11 and a frame portion 12. The main body portion 11 has an axially extending tubular shape. The center of the main body portion 11 coincides with the central axis Ax. The main body portion 11 has, for example, a waterproof structure, a dustproof structure, or the like, i.e., a structure in which foreign substances such as water and dust do not easily enter inside, and the battery 81 is disposed inside the main body portion 11. That is, the body portion 1 includes the battery 81. Doing this allows the battery 81, which is heavy, to be disposed at the radial center of the unmanned aerial vehicle Dr1, and hence the unmanned aerial vehicle Dr1 can be well balanced. This can improve the operability of the unmanned aerial vehicle Dr1. The battery 81 is a power source that supplies power to the main motor 4 and the three auxiliary motors 7. The battery 81 may be charged via a connector (not illustrated) provided in the main body portion 11 or may be charged with the battery 81 removed from the main body portion 11.

An axial lower surface 111 of the main body portion 11 is a downwardly convex curved surface that is radially inward as going axially downward. That is, in the lower surface 111, the radially central portion is the axially lowermost end. A translucent window portion 112 is provided at the radial center portion of the lower surface 111. The gap between the lower surface 111 and the window portion 112 also has a structure that suppresses entry of foreign substances. Inside the main body portion 11 is provided with the camera 82. That is, the body portion 1 includes the camera 82. Doing this allows the camera 82, which is heavy, to be disposed at the radial center of the unmanned aerial vehicle Dr1. This improves the balance of the unmanned aerial vehicle Dr1 and can thus improve the operability. The camera 82 photographs the outside of the main body portion 11 through the window portion 112. Due to this, the camera 82 is less likely to be exposed to foreign substances such as water and dust, and the camera 82 can be operated stably.

The frame portion 12 expands in the direction orthogonal to the central axis Ax. That is, the body portion 1 includes the main body portion 11 and the frame portion 12, which expands in the direction orthogonal to the central axis Ax of the main shaft 2. The frame portion 12 includes a frame body portion 121 and three arm portions 122. The frame body portion 121 is disposed at the radial center as the frame portion 12 is viewed axially. As shown in FIG. 2 and the like, in the frame portion 12, the three arm portions 122 each extend radially outward from the frame body portion 121, and are disposed at equal intervals in the circumferential direction. That is, the frame portion 12 includes the frame body portion 121 and the plurality of arm portions 122, which radially extend from the frame body portion 121. By the frame portion 12 including the arm portion 122, the frame portion 12 extends radially outward, and an axial projection area can be reduced. As a result, the position of the auxiliary propeller 6 is separated from the central axis Ax, and the air flow due to the rotation of the main propeller 3 and the three auxiliary propellers 6 is hardly hindered. Therefore, the unmanned aerial vehicle Dr1 can be driven efficiently.

The unmanned aerial vehicle Dr1 is preferably lightweight. Therefore, the main body portion 11 and the frame portion 12 may each be integrally molded of resin or metal. Provided as an integrally molded body, screws and other joining members and welding, adhesion, and other joining agents are unnecessary, and the weight can be reduced accordingly. As shown in FIG. 3, the main body portion 11 and the frame portion 12 are connected via the main shaft 2. Next, the main shaft 2 will be described.

As shown in FIGS. 2 and 3, the main shaft 2 is a cylindrical body extending axially upward from an axial upper surface of the main body portion 11. That is, the main shaft 2 extends axially from the body portion 1. The central axis of the main shaft 2 coincides with the central axis Ax of the unmanned aerial vehicle Dr1. Therefore, the central axis Ax of the main shaft 2 may be described as the central axis of the main shaft 2. The main shaft 2 is fixed with the main body portion 11 and the frame portion 12. The main shaft 2 is hollow and has an internal space 21. The lower end portion of the main shaft 2 is connected to the main body portion 11, and the upper end portion of the main shaft 2 is connected to the frame portion 12. The internal space 21 of the main shaft 2 communicates with the inside of the main body portion 11.

A lead wire 84 is connected to the battery 81 disposed inside the main body portion 11. The lead wire 84 is wired in the internal space 21 of the main shaft 2. The lead wire 84 connects the battery 81 and the circuit board 83 included in the frame portion 12. The frame portion 12 includes a space that can accommodate the circuit board 83 inside. The circuit board 83 may be attached to the outer surface of the frame portion 12 if the circuit board 83 has a configuration in which malfunction due to foreign substances is less likely to occur or if the unmanned aerial vehicle Dr1 is used in an environment with few foreign substances.

The main motor 4 and the auxiliary motor 7 are controlled by a control circuit (not illustrated) mounted on the circuit board 83. Therefore, the main motor 4 and the auxiliary motor 7 and the circuit board 83 are connected via the lead wire 84. That is, the lead wire 84 connects the battery 81 and the circuit board 83, at the same time, it is an example of a connection wire that electrically connects the main motor 4, which is the main driver, with at least one of the auxiliary motors 7, which are the three auxiliary drivers. By disposing the lead wire 84 in the internal space 21 of the main shaft 2, the lead wire 84 is protected. Although the lead wire 84 connects the battery 81 with the circuit board 83, it is not limited to this. For example, the battery 81 and at least one of the main motor 4 and the auxiliary motor 7 may be directly connected. However, in order to easily control the main motor 4 and the auxiliary motor 7, it is preferable that the main motor 4 and the auxiliary motor 7 are connected to the circuit board 83 via the lead wire 84 and power is supplied from the control circuit of the circuit board 83 to the main motor 4 and the auxiliary motor 7.

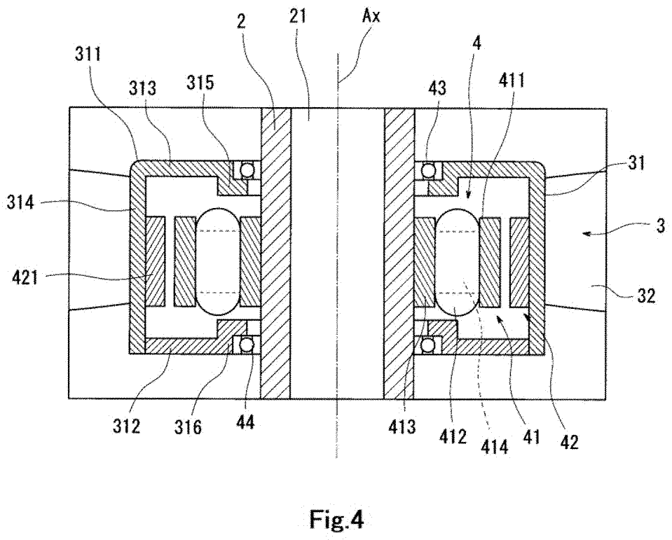

The main motor 4 is attached to the main shaft 2. The main propeller 3 is connected to the main shaft 2 via the main motor 4. That is, the main propeller 3 is connected to the main shaft 2. The main motor 4 is an example of a main driver. FIG. 4 is an enlarged sectional view of the main propeller and the main motor.

First, the main propeller 3 will be described. As shown in FIGS. 2 and 3, the unmanned aerial vehicle Dr1 includes one main propeller 3. As shown in FIGS. 1 to 4, the main propeller 3 includes a main propeller body portion 31 and three main blade portions 32. That is, the main propeller 3 includes the propeller body portion 31 and the plurality of main blade portions 32, which extend radially outward from the propeller body portion 31 and are circumferentially disposed. Although the main propeller 3 includes the three main blade portions 32, it is not limited to this. As long as it can generate sufficient lift, the number of main blade portions may be two or be four or more.

As shown in FIGS. 3 and 4, the main propeller body portion 31 includes an upper cover 311 and a lower cover 312. The upper cover 311 has a lidded tubular shape. The upper cover 311 includes an annular upper lid portion 313 expanding in a direction orthogonal to the central axis Ax, and a cylindrical main propeller tubular portion 314 extending axially downward from a radial outer edge of the upper lid portion 313. The radial center of the upper lid portion 313 is provided with an upper bearing holding portion 315 that axially penetrates. An upper bearing 43 of the main motor 4 is held by the upper bearing holding portion 315.

The lower cover 312 has an annular shape expanding in a direction orthogonal to the central axis Ax. The lower cover 312 includes a lower bearing holding portion 316 that axially penetrates at the radial center. A lower bearing 44 of the main motor 4 is held by the lower bearing holding portion 316. The lower cover 312 is fixed with the main propeller tubular portion 314 of the upper cover 311 at a radial outer edge portion. The upper cover 311 and the lower cover 312 may be fixed by press fitting. Alternatively, the lower cover 312 may be fixed by screwing into the upper cover 311 with a male screw formed on a radial outer surface of the lower cover 312 and a female screw formed on an inner surface of the main propeller tubular portion 314. Furthermore, adhesion, welding, or the like may be used. A wide range of methods capable of securely fixing the upper cover 311 and the lower cover 312 can be adopted.

An inner ring of the upper bearing 43 and an inner ring of the lower bearing 44 are fixed to the main shaft 2 at positions separated vertically in the axial direction. That is, the main propeller 3 is rotatably connected to the main shaft 2 via the upper bearing 43 and the lower bearing 44.

The three main blade portions 32 extend radially outward from the radial outer surface of the main propeller tubular portion 314. The three main blade portions 32 are fixed to the main propeller tubular portion 314. The main propeller tubular portion 314 and the three main blade portions 32 may be formed by integral molding. The three main blade portions 32 are disposed at equal intervals in the circumferential direction.

Next, the main motor 4 will be described. The main motor 4 is disposed at an axial intermediate portion of the main shaft 2. The main motor 4 is disposed inside the main propeller body portion 31 of the main propeller 3. That is, a driver 4 is housed inside the propeller body portion 31. The main motor 4 is an outer rotor type motor. The main motor 4 includes a stator 41 and a rotor 42. The stator 41 includes a stator core 411 and a coil 412. The stator core 411 is a laminate in which, for example, electromagnetic steel sheets are axially laminated. Note that the stator core 411 is not limited to a laminate in which electromagnetic steel sheets are laminated, and may be a single member such as a fired body of powder or a casting.

The stator core 411 includes an annular core back 413 and a plurality of teeth 414. The main shaft 2 is press-fitted into the central penetration portion of the annular core back 413. Thus, the stator core 411 is fixed to an axial intermediate portion of the main shaft 2. That is, the stator 41 is fixed to the main shaft 2. The plurality of teeth 414 extend radially outward from the radial outer surface of the core back 413, and are formed radially. The coil 412 is configured by winding a wire around each of the teeth 414.

The rotor 42 includes a cylindrical rotor magnet 421. The rotor magnet 421 radially faces the teeth 414 of the stator core 411. The rotor magnet 421 is fixed to a radial inner surface of the main propeller tubular portion 314. That is, the main motor 4 uses the main propeller tubular portion 314 as a rotor housing. In the rotor magnet 421, N poles and S poles are alternately disposed in the circumferential direction.

The upper bearing 43 and the lower bearing 44 are ball bearings. The upper bearing 43 and the lower bearing 44 include an outer ring, the inner ring, and a plurality of balls disposed between the outer ring and the inner ring. The outer ring of the upper bearing 43 is fixed to the upper bearing holding portion 315 of the upper cover 311. The outer ring of the lower bearing 44 is fixed to the lower bearing holding portion 316 of the lower cover 312. The inner rings of the upper bearing 43 and the lower bearing 44 are fixed to axially separated portions of the main shaft 2. The outer rings of the upper bearing 43 and the lower bearing 44 and the upper bearing holding portion 315 and the lower bearing holding portion 316 are fixed by press-fitting, for example. However, fixation is not limited to this. Moreover, although the inner rings of the upper bearing 43 and the lower bearing 44 and the main shaft 2 are fixed also by press-fitting, fixation is not limited to this.

In the main motor 4, the coil 412 is excited by supplying a current to the coil 412. As a result, an attractive force or a repulsive force due to the magnetic force is generated between the coil 412 and the rotor magnet 421. By adjusting the timing of the current supplied to the coil 412, a circumferentially rotating force acts on the rotor magnet 421. The upper cover 311 rotatably supported by the main shaft 2 via the upper bearing 43 by the force acting on the rotor magnet 421 and the lower cover 312 rotatably supported by the main shaft 2 via the lower bearing 44 rotate around the central axis Ax.

As a result, the main blade portion 32 fixed to the main propeller tubular portion 314 rotates around the central axis Ax. In other words, the main propeller 3 rotates around the central axis Ax. As the main propeller 3 rotates, air is pushed by the main blade portion 32 to generate an axially downward air flow. As a result, the unmanned aerial vehicle Dr1 obtains an axially upward force (lift). The rotational direction of the main propeller 3 is a counterclockwise CCW direction as viewed from axially above, in other words, in FIG. 3.

In the unmanned aerial vehicle Dr1, the main propeller 3 and the main motor 4 are disposed between the main body portion 11 and the frame portion 12. Disposing in this manner allows the axial length of the unmanned aerial vehicle Dr1 to be shortened. Since the main motor 4 is an outer rotor motor and configured to be attached to the main shaft 2, the drive power of the main motor 4 is reliably transmitted to the main propeller 3, and hence the drive efficiency is high.

The three auxiliary shafts 5 included in the unmanned aerial vehicle Dr1 are identical-shaped members formed of an identical material. Therefore, in the following description, the same features will be described for all the auxiliary shafts 5 unless otherwise stated. As shown in FIG. 3, the auxiliary shaft 5 extends axially upward from the radially outward end portion of the arm portion 122. That is, the plurality of auxiliary shafts 5 extend axially from (the arm portion 122 of the frame portion 12 included in) the body portion 1. The auxiliary shaft 5 is fixed to the arm portion 122. A central axis Ax1 of the auxiliary shaft 5 is parallel to the central axis Ax of the main shaft 2, that is to say, the central axis Ax of the unmanned aerial vehicle Dr1. That is, the central axes Ax1 of the plurality of auxiliary shafts 5 are parallel to the central axis Ax of the main shaft 2 . Thus, the axial length of the auxiliary propeller 6 can be shortened, and the axial height of the unmanned aerial vehicle Dr1 can be suppressed.

The auxiliary shaft 5 and the arm portion 122 may be formed to be hollow, and the internal space of each may be continuous. By doing this, the lead wire connecting the circuit board 83 and the auxiliary motor 7 can be housed inside the arm portion 122 and the auxiliary shaft 5.

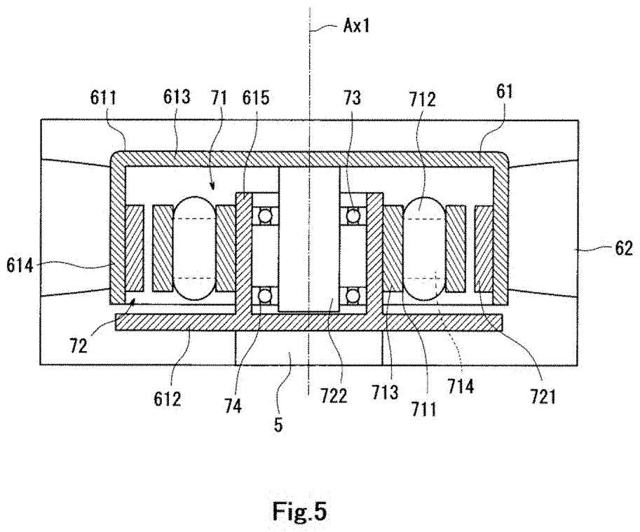

The auxiliary propeller 6 and the auxiliary motor 7 will be described with reference to the drawings. FIG. 5 is an enlarged sectional view of the auxiliary propeller 6 and the auxiliary motor 7. The auxiliary motor 7 is attached to the axial upper end of the auxiliary shaft 5. That is, the plurality of auxiliary drivers 7 that drive the plurality of auxiliary propellers 6 are connected to the frame portion 12. Furthermore, the plurality of auxiliary drivers 7 are connected to the respective arm portions 122. The auxiliary propeller 6 is connected to the axial upper end of the auxiliary shaft 5 via the auxiliary motor 7. The three auxiliary propellers 6 are connected to the three auxiliary shafts 5 respectively. That is, the plurality of auxiliary propellers 6 are connected to the plurality of auxiliary shafts 5 respectively. The auxiliary motor 7 is an example of the auxiliary driver.

First, the auxiliary propeller 6 will be described. As shown in FIGS. 2 and 3, the unmanned aerial vehicle Dr1 includes the three auxiliary propellers 6. The auxiliary propeller 6 includes an auxiliary propeller body portion 61 and three auxiliary blade portions 62. As shown in FIG. 5, the auxiliary propeller body portion 61 includes an upper cover 611 and a lower cover 612. The upper cover 611 has a lidded tubular shape. The upper cover 611 includes an annular upper lid portion 613 expanding in a direction orthogonal to the central axis Ax1 of the auxiliary shaft 5, and a cylindrical auxiliary propeller tubular portion 614 extending axially downward from the radial outer edge of the upper lid portion 613. The axial upper surface of the rotor shaft 722 is fixed to the axial lower surface of the upper lid portion 613. That is, the rotor shaft 722 extends axially downward from the radial middle portion of the axial lower surface of the upper lid portion 613. The upper lid portion 613 may be provided with an axially penetrating hole portion, and the upper end portion of the rotor shaft 722 may be fixed to the hole portion. The upper lid portion 613 and the rotor shaft 722 may be an integral member.

The lower cover 612 is in a disc form expanding in a direction orthogonal to the central axis Ax1 of the auxiliary shaft 5. The radial center portion of the lower cover 612 is provided with a tubular bearing holding portion 615 extending axially upward. An upper bearing 73 and a lower bearing 74 of the auxiliary motor 7 are held by the bearing holding portion 615. The lower cover 612 axially faces the lower surface of the auxiliary propeller tubular portion 614 of the upper cover 611 at the radial outer edge portion.

The three auxiliary blade portions 62 extend radially outward from the radial outer surface of the auxiliary propeller tubular portion 614. That is, at least one of the plurality of auxiliary propellers 6 includes the propeller body portion 61 and the plurality of blade portions 62, which extend radially outward from the propeller body portion 61 and are circumferentially disposed. Note that although the auxiliary propeller 6 includes the three auxiliary blade portions 62, it is not limited to this. It may be two or be four or more as long as it can generate sufficient lift.

The three auxiliary blade portions 62 are fixed to the auxiliary propeller tubular portion 614. The auxiliary propeller tubular portion 614 and the three auxiliary blade portions 62 may be formed by integral molding. The three auxiliary blade portions 62 are disposed at equal intervals in the circumferential direction. The lower cover 612 is fixed to an axial upper end of the auxiliary shaft 5.

Next, the auxiliary motor 7 will be described. The auxiliary motor 7 is disposed at an axial upper end portion of the auxiliary shaft 5. The auxiliary motor 7 is disposed inside the auxiliary propeller body portion 61 of the auxiliary propeller 6. That is, at least one of the plurality of auxiliary propellers 6 radially faces the driver 7. The driver 7 is housed inside the propeller body portion 61. This configuration allows the axial length of the rotor shaft 722 to be shortened, and the transmission efficiency of the driving force to be enhanced. The auxiliary motor 7 is an outer rotor type motor. The auxiliary motor 7 includes a stator 71 and a rotor 72. The stator 71 includes a stator core 711 and a coil 712. The stator core 711 is a laminate in which, for example, electromagnetic steel sheets are axially laminated. Note that the stator core 711 is not limited to a laminate in which electromagnetic steel sheets are laminated, and may be a single member such as a fired body of powder or a casting.

The stator core 711 includes an annular core back 713 and a plurality of teeth 714. The bearing holding portion 615 is press-fitted into the central penetration portion of the annular core back 713. Thus, the stator core 711 is fixed to an axial intermediate portion of the bearing holding portion 615. That is, the stator 71 is fixed to the lower cover 612 via the bearing holding portion 615. The plurality of teeth 714 extend radially outward from the radial outer surface of the core back 713, and are formed radially. The coil 712 is configured by winding a wire around each of the teeth 714.

The rotor 72 includes a cylindrical rotor magnet 721 and a rotor shaft 722. The rotor magnet 721 radially faces the teeth 714. The rotor magnet 721 is fixed to a radial inner surface of the auxiliary propeller tubular portion 614. In the rotor magnet 721, N poles and S poles are alternately disposed in the circumferential direction. That is, the auxiliary motor 7 uses the auxiliary propeller tubular portion 614 as a rotor housing.

The rotor shaft 722 is fixed to the upper lid portion 613 of the upper cover 611. The rotor shaft 722 rotates together with the upper cover 611.

The upper bearing 73 and the lower bearing 74 are ball bearings. The upper bearing 73 and the lower bearing 74 include an outer ring, the inner ring, and a plurality of balls disposed between the outer ring and the inner ring. In the upper bearing 73 and the lower bearing 74, the inner ring and the outer ring relatively rotate as the balls rotate. The outer ring of the upper bearing 73 is fixed to the bearing holding portion 615. In addition, the outer ring of the lower bearing 74 is also fixed to the bearing holding portion 615. Although fixation of the outer rings of the upper bearing 73 and the lower bearing 74 and the bearing holding portion 615 may include press-fit, it is not limited to this. The inner rings of the upper bearing 73 and the lower bearing 74 are fixed to axially separated portions of the rotor shaft 722. Although fixation of the outer rings of the upper bearing 73 and the lower bearing 74 and the rotor shaft 722 may include press-fit, it is not limited to this.

This causes the rotor shaft 722 to be rotatably supported by the bearing holding portion 615 via the upper bearing 73 and the lower bearing 74. More specifically, the rotor shaft 722 and the upper cover 611 fixed to the rotor shaft 722 are rotatably supported relative to the lower cover 612.

In the auxiliary motor 7, the coil 712 is excited by supplying a current to the coil 712. As a result, an attractive force or a repulsive force due to the magnetic force is generated between the coil 712 and the rotor magnet 721. By adjusting the timing of the current supplied to the coil 712, a circumferentially rotating force acts on the rotor magnet 721. Then, a force acting on the rotor magnet 721 acts on the upper cover 611. Due to this, the upper cover 611 rotates around the central axis Ax1 of the auxiliary shaft 5 together with the rotor shaft 722.

As a result, the auxiliary blade portion 62 fixed to the auxiliary propeller tubular portion 614 of the upper cover 611 rotates around the central axis Ax1 of the auxiliary shaft 5. In other words, the auxiliary propeller 6 rotates around the central axis Ax1 of the auxiliary shaft 5. As the auxiliary propeller 6 rotates, air is pushed by the auxiliary blade portion 62 to generate an axially downward air flow. This causes the unmanned aerial vehicle Dr1 to obtain upward lift along the central axis Ax1 of the auxiliary shaft 5.

The rotational direction of the auxiliary propeller 6 is a clockwise CW direction as viewed from axially above, in other words, in FIG. 3. Note that currents are supplied to the three auxiliary motors 7 from the respective different lead wires 84. Therefore, each of the three auxiliary motors 7 can rotate at a rotation speed different from that of the other auxiliary motors 7. That is, each of the plurality of auxiliary propellers 6 can be driven at a rotation speed different from that of the other auxiliary propellers 6.

The relationship between the main propeller 3 and the main motor 4 and the auxiliary propeller 6 and the auxiliary motor 7 will be described. As shown in FIGS. 2, 3, and the like, the radial length of the main blade portion 32 of the main propeller 3 is longer than that of the auxiliary blade portion 62 of the auxiliary propeller 6. Then, as shown in FIGS. 2 and 3, as the unmanned aerial vehicle Dr1 is viewed axially, at least a part of a locus St2 of the radial outer edge portion of the auxiliary blade portion 62 of the auxiliary propeller 6 is positioned inside a locus St1 of the radial outer edge portion of the main blade portion 32 of the main propeller 3. That is, the circle St1 drawn by the tip of the main propeller and the circle St2 drawn by the tip of each of the plurality of auxiliary propellers 6 axially overlap at least partially. This configuration allows the unmanned aerial vehicle Dr1 to be downsized as compared with an unmanned aerial vehicle having a configuration in which not all propellers axially overlap.

In the unmanned aerial vehicle Dr1, the main body portion 11 and the frame portion 12 are connected via the main shaft 2, and the main motor 4 and the main propeller 3 are attached to the axial intermediate portion of the main shaft 2. The auxiliary motor 7 and the auxiliary propeller 6 are attached to the auxiliary shaft 5 that protrudes axially upward from the frame portion 12. That is, the frame portion 12 is disposed axially between the main propeller 3 and the plurality of auxiliary propellers 6. Then, the plurality of auxiliary drivers 7 that drive the plurality of auxiliary propellers 6 among the plurality of drivers 3 and 7 are connected to the frame portion 12. By disposing the main motor 4 in the intermediate portion of the main shaft 2, a force generated in the main motor 4 can be efficiently transmitted to the main propeller 3. Due to this, the rotation accuracy of the main propeller 3 can be enhanced, and thus noise generated when the propeller rotates can be reduced.

The main propeller 3 rotates around the central axis Ax of the unmanned aerial vehicle Dr1 by the main motor 4. Therefore, the rotation of the main propeller 3 causes an axial upward force to act on the radial center of the main body portion 11, that is, the body portion 1. On the other hand, the three auxiliary propellers 6 respectively rotate by the three auxiliary motors 7 around the central axis Ax1 of the auxiliary shaft 5 radially offset from the central axis Ax of the unmanned aerial vehicle Dr1. Therefore, the rotation of the three auxiliary propellers 6 causes an upward force to act on, along the central axis Ax1 of the auxiliary shaft 5, the frame portion 12, that is, the position where each of the three auxiliary shafts 5 of the body portion 1 is connected. That is, the plurality of drivers (motors) 4 and 7 drive the main propeller 3 and the plurality of auxiliary propellers 6. Since the central axis Ax and the central axis Ax1 are parallel, the direction of force acting on the body portion 1 from the main propeller 3 and the direction of force acting on the body portion 1 from each of the three auxiliary propellers 6 are the same.

The three auxiliary propellers 6 adjust an axial force acting on the body portion 1 by the rotation speed. As shown in FIG. 2, the three auxiliary propellers 6 have equal radial lengths from the central axis Ax of the unmanned aerial vehicle Dr1, and are disposed at equal intervals in the circumferential direction. Therefore, by applying an equal force to the frame portion 12 from the three auxiliary propellers 6, it is possible to maintain the attitude of the unmanned aerial vehicle Dr1 with respect to the horizon. In addition, all the three auxiliary propellers 6 have the same shape. Therefore, by rotating all the three auxiliary propellers 6 at the same rotation speed, the forces acting on the frame portion 12 from the three auxiliary propellers 6 become equal.

The unmanned aerial vehicle Dr1 can be kept horizontal by rotating the three auxiliary propellers 6 at the same rotation speed when the unmanned aerial vehicle Dr1 is horizontal, for example. The attitude of the unmanned aerial vehicle Dr1 with respect to the horizon can be changed by adjusting the rotation speeds of the three auxiliary propellers 6. In addition, horizontal movement is also possible by changing the attitude of the unmanned aerial vehicle Dr1 with respect to the horizon.

As described above, the radial length of the main blade portion 32 is larger than the radial length of the auxiliary blade portion 62. Therefore, in order to rotate the main propeller 3, a large force, that is, a large torque is required as compared with a case of rotating the auxiliary propeller 6. In a case of an aerial vehicle that generates lift by wind power by the rotation of a propeller and moves vertically such as the unmanned aerial vehicle Dr1, on the other hand, a torque in the opposite direction to the rotational direction of the propeller to act on the body portion 1 due to the rotation of the propeller. The torque acting on the body portion 1 due to the rotation of the propeller is determined by the size and rotation speed of the propeller. That is, in the three auxiliary propellers 6, the rotation speed, that is, the lift by the air flow generated from the auxiliary propeller 6 is proportional to the torque.

In the unmanned aerial vehicle Dr1, the rotational direction (CCW direction) of the main propeller 3 and the rotational direction (CW direction) of the auxiliary propeller 6 are opposite to each other. That is, as viewed from one axial side of the main shaft 2, the rotational direction (CW direction) of the plurality of auxiliary propellers 7 is opposite to the rotational direction (CCW direction) of the main propeller 3. Due to this, a main torque Tr1 acting on the body portion 1 from the main motor 4 by the rotation of the main propeller 3 and auxiliary torques Tr21, Tr22, and Tr23 acting on the body portion 1 from the auxiliary motor 7 by the rotation of the three auxiliary propellers 6 cancel each other.

For example, with the three auxiliary propellers 6 rotating at the same rotation speed, if the sum of the force acting on the body portion 1 from the main propeller 3 and the force acting on the body portion 1 from the three auxiliary propellers 6 coincides with the weight of the unmanned aerial vehicle Dr1, the vertical position of the unmanned aerial vehicle Dr1 is fixed. When the attitude of the unmanned aerial vehicle Dr1 is horizontal and the main torque Tr1 balances with the sum of the auxiliary torques Tr21, Tr22, and Tr23, the unmanned aerial vehicle Dr1 stops also in the rotational direction with the horizontal attitude. Note that a state in which a horizontal attitude is maintained without rotation is referred to as a hovering state. That is, when the body portion 1 is hovering in the air, the torque Tr1 acting on the body portion 1 from the main propeller 3 and the sum of the torques Tr21, Tr22, and Tr23 acting on the body portion 1 from the plurality of auxiliary propellers 7 are the same.

That is, when in the hovering state, the unmanned aerial vehicle Dr1 obtains a sufficient lift by the rotation of the main propeller 3 and the three auxiliary propellers 6, and the main torque Tr1 and the sum of the auxiliary torques Tr21, Tr22, and Tr23 are balanced. In the unmanned aerial vehicle Dr1, when all the three auxiliary propellers 6 rotate at the same rotation speed, the main torque Tr1 and the sum of the auxiliary torques Tr21, Tr22, and Tr23 are balanced. Due to this, a stable operation of the unmanned aerial vehicle Dr1 is made possible with simple control.

Also, as described above, when the unmanned aerial vehicle Dr1 moves in the air, the rotation speeds of the three auxiliary propellers 6 are adjusted, in other words, controlled to different rotation speeds. That is, the unmanned aerial vehicle Dr1 moves in the air by setting the rotation speed of at least one of the three auxiliary propellers 6 to a rotation speed different from that of the other auxiliary propellers 6. And the torque acting on the flame portion 12 from the auxiliary propeller 6 changes with the rotation speed. Therefore, when the unmanned aerial vehicle Dr1 is moving, at least one of the auxiliary propellers 6 rotates at a rotation speed different from that of the other auxiliary propellers 6, and the main torque Tr1 and the sum of the auxiliary torques Tr21, Tr22, and Tr23 are different. That is, the torque Tr1 acting on the body portion 1 from the main propeller 3 when the body portion 1 is moving in the air is different from the sum of the torques Tr21, Tr22, and Tr23 acting on the body portion 1 from the plurality of auxiliary propellers 6. This makes it easy to control the movement of the unmanned aerial vehicle Dr1 in the air.

By making the radial length of the main blade portion 32 longer than the radial length of the auxiliary blade portion 62, the main propeller 3 can generate an enough lift to cause the unmanned aerial vehicle Dr1 to float at a lower rotation speed than that of the auxiliary propeller 6. By providing the main propeller 3, the lift required for each of the three auxiliary propellers 6 is also reduced. That is, the rotation speeds of the three auxiliary propellers 6 can also be kept low. This allows the unmanned aerial vehicle Dr1 of the present disclosure to keep the rotation speed of each propeller lower as compared with an unmanned aerial vehicle using four same propellers.

Due to this, noise such as wind noise due to the rotation of the propeller can be reduced. By suppressing the noise of the unmanned aerial vehicle Dr1, it is possible to increase the convenience, for example, in a case of indoor use or in a case of mounting an acoustic device such as a speaker or a microphone. In addition, even in a case of outdoor use, by suppressing the noise of the unmanned aerial vehicle Dr1, the convenience is high for use in a place where the noise is desired to be suppressed.

In the unmanned aerial vehicle Dr1, the main propeller 3 is disposed axially between the main body portion 11 and the frame portion 12. A main driver 4 that drives the main propeller 3 is disposed axially between the main body portion 11 and the frame portion 12. The plurality of auxiliary drivers 7 are disposed in the frame portion 12. The main body portion 11 and the frame portion 12 are connected via the hollow shaft 2, and a connection wire 84 that electrically connects at least one of the main driver 4 and the plurality of auxiliary drivers 7 is disposed inside the hollow shaft 2.

An actual example of the unmanned aerial vehicle Dr1 of the present example embodiment will be described. An example of the unmanned aerial vehicle Dr1 of the present example embodiment is taken as Example 1. The unmanned aerial vehicle Dr1 of Example 1 is capable of generating a lift of 50 g. The unmanned aerial vehicle Dr1 of Example 1 uses the main propeller 3 having an outermost diameter, that is, the outer diameter of the locus St1 of the radially outer end of the main blade portion 32 of 120 mm. The unmanned aerial vehicle Dr1 of Example 1 also uses the three auxiliary propellers 6 each having an outermost diameter, that is, the outer diameter of the locus St2 of the radially outer end of the auxiliary blade portion 62 of 50 mm. The main motor 4 and the auxiliary motor 7 are outer rotor motors.

The weight of the body portion 1 and the like are 20 g. The weight of the main propeller 3 is 3 g and the weight of the main motor 4 is 4 g, thus the total of 7 g. The weight of the auxiliary propeller 6 is 1 g and the weight of the auxiliary motor 7 is 1.5 g, and the total of the three auxiliary propellers 6 and the three auxiliary motors 7 is 7.5 g. The weight of the battery 81 is 8 g, the weight of the camera 82 is 3 g, and the weight of the circuit board 83 is 1 g. Therefore, the total weight of Example 1 is 46.5 g. With this configuration, the unmanned aerial vehicle Dr1 can fly.

Next, a comparison was made with an unmanned aerial vehicle also having four propellers. An example of the unmanned aerial vehicle Dr1 of the present example embodiment is taken as Example 2. Example 2 uses the main propeller 3 having an outermost diameter, that is, the outer diameter of the locus St1 of the radially outer end of the main blade portion 32 of 150 mm. The unmanned aerial vehicle Dr1 of Example 1 also uses the three auxiliary propellers 6 each having an outermost diameter, that is, the outer diameter of the locus St2 of the radially outer end of the auxiliary blade portion 62 of 100 mm. The main motor 4 and the auxiliary motor 7 are outer rotor motors.

As a comparative example, an unmanned aerial vehicle using four propellers having an outer diameter of 100 mm was prepared. For Example 2 and the comparative example, the rotation speed of the propeller, which is a main factor of noise during hovering, was examined. The rotation speed of all the propellers in the case of the comparative example was 10000 rpm meanwhile the rotation speed of the main propeller 3 was 5000 rpm and that of the auxiliary propeller 6 was 7500 rpm in Example 2. The rotation speeds of the main propeller 3 and the auxiliary propeller 6 of Example 2 are smaller than the rotation speed of the propellers of the comparative example. That is, the unmanned aerial vehicle according to the present disclosure is quieter than a conventional unmanned aerial vehicle in which all propellers have the same shape.

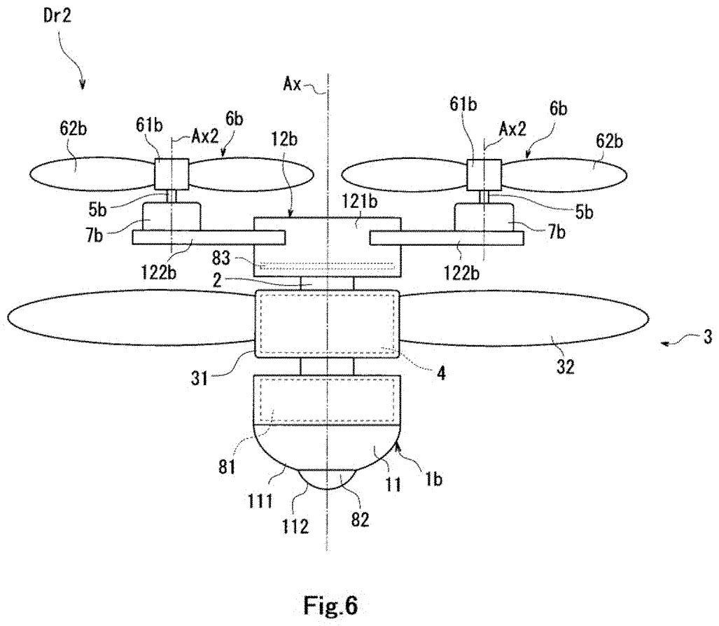

Another example of the unmanned aerial vehicle according to the present disclosure will be described with reference to the drawings. FIG. 6 is a schematic side view of another example of the unmanned aerial vehicle according to the present disclosure. An unmanned aerial vehicle Dr2 shown in FIG. 6 has the same configuration as that of the unmanned aerial vehicle Dr1 of the first example embodiment except that a frame portion 12b of a body portion 1b, an auxiliary shaft 5b, an auxiliary propeller 6b, and an auxiliary motor 7b are different from the frame portion 12, the auxiliary shaft 5, the auxiliary propeller 6, and the auxiliary motor 7. For this reason, in the configuration of the unmanned aerial vehicle Dr2, the same components as those of the unmanned aerial vehicle Dr1 are given the same reference numerals and detailed descriptions thereof will be omitted.

As shown in FIG. 6, the frame portion 12b of the body portion 1b of the unmanned aerial vehicle Dr2 includes a frame body portion 121b and three arm portions 122b. The frame body portion 121b has an axially extending cylindrical shape. The center of the frame body portion 121b coincides with the central axis Ax. The frame body portion 121b has a space inside, and the circuit board 83 is disposed in the internal space of the frame body portion 121b. The internal space of the main shaft 2 communicates with the internal space of the frame body portion 121b. Then, the lead wire disposed inside the main shaft 2 is connected to the circuit board 83 inside the frame body portion 121b.

The three arm portions 122b extend radially outward from a radial outer surface of the frame body portion 121b. The three arm portions 122b are disposed at equal intervals in the circumferential direction. Then, the auxiliary motor 7b is attached to the axial upper surface of the radial outer edge of the arm portion 122b. The arm portion 122b may include a hollow portion. Where the arm portion 122b includes the hollow portion, the lead wire connected from the circuit board 83 to the auxiliary motor 7b can be wired in the hollow portion.

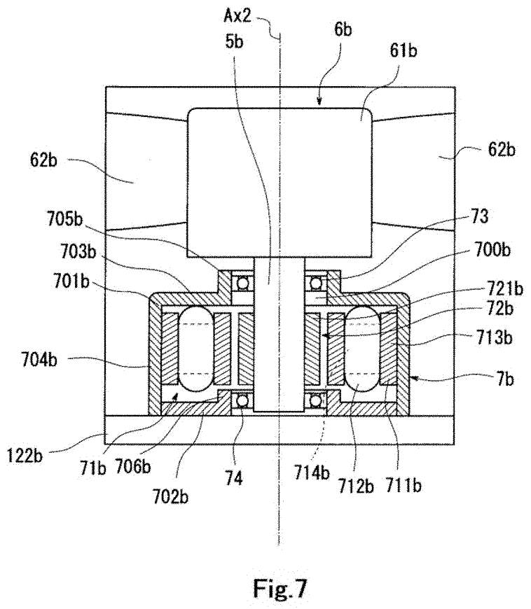

The auxiliary propeller 6b and the auxiliary motor 7b will be described with reference to the drawings. FIG. 7 is a schematic view of the auxiliary propeller 6b and the auxiliary motor 7b. The auxiliary motor 7b is an inner rotor type motor. The auxiliary motor 7b is fixed to the axial upper surface of the arm portion 122b. The auxiliary motor 7b includes an upper cover 701b, a base portion 702b, a stator 71b, a rotor 72b, the upper bearing 73, and the lower bearing 74.

The upper cover 701b has a lidded tubular shape. The upper cover 701b includes an upper lid portion 703b, an auxiliary motor tubular portion 704b, and an upper bearing holding portion 705b. The upper lid portion 703b has an annular shape expanding in a direction orthogonal to a central axis Ax2 of the auxiliary shaft 5b, and has a through hole 700b at the center. The auxiliary motor tubular portion 704b extends axially downward from a radial outer edge portion of the upper lid portion 703b. The upper bearing holding portion 705b has a tubular shape extending axially upward from the side edge portion of the through hole 700b of the upper lid portion 703b. The center of the upper bearing holding portion 705b coincides with the central axis Ax2 of the auxiliary shaft 5b.

The base portion 702b has an annular shape expanding in a direction orthogonal to the central axis Ax2 of the auxiliary shaft 5b. The base portion 702b includes a lower bearing holding portion 706b. The lower bearing holding portion 706b has a cylindrical shape, and is disposed at the radial center portion of the base portion 702b. The center of the lower bearing holding portion 706b overlaps the central axis Ax2 of the auxiliary shaft 5b.

The outer ring of the upper bearing 73 is fixed to a radial inner surface of the upper bearing holding portion 705b. Due to this, the center of the inner ring of the upper bearing 73 overlaps the central axis Ax2 of the auxiliary shaft 5b. The outer ring of the lower bearing 74 is fixed to a radial inner surface of the lower bearing holding portion 706b. Due to this, the center of the inner ring of the lower bearing 74 overlaps the central axis Ax2 of the auxiliary shaft 5b. The auxiliary shaft 5b is fixed to the inner rings of the upper bearing 73 and the lower bearing 74 by press-fitting. This causes the auxiliary shaft 5b to be rotatably supported by the upper cover 701b and the base portion 702b. The auxiliary shaft 5b protrudes outward axially upward from the through hole at the radial center of the upper lid portion 703b of the upper cover 701b. The auxiliary shaft 5b extends axially upward from the arm portion 122b, that is, the body portion 1b, via the auxiliary motor 7b.

The stator 71b includes a stator core 711b and a coil 712b. The stator core 711b includes an annular core back 713b and a plurality of teeth 714b. The annular core back 713b is fixed to a radial inner surface of the auxiliary motor tubular portion 704b. The plurality of teeth 714b extend radially inward from the annular core back 713b. The coil 712b is configured by winding a wire around each of the teeth 714b.

The rotor 72b includes a rotor magnet 721b. The rotor magnet 721b is cylindrical and fixed to a radial outer surface of the auxiliary shaft 5b. The rotor magnet 721b radially faces the teeth 714b. The auxiliary shaft 5b is press-fitted into the inner rings of the upper bearing 73 and the lower bearing 74, and the rotor 72b is rotatable with respect to the upper cover 701b and the base portion 702b. The auxiliary shaft 5b rotates around the central axis Ax2 of the auxiliary shaft 5b by supplying a current to the coil 712b.

The auxiliary propeller 6b is fixed to the upper end portion of the auxiliary shaft 5b. The auxiliary propeller 6b includes an auxiliary propeller body portion 61b and an auxiliary blade portion 62b. The auxiliary propeller body portion 61b is columnar, and the center of the auxiliary propeller body portion 61b overlaps the central axis Ax2 of the auxiliary shaft 5b. The auxiliary blade portion 62b extends radially outward from the radial outer surface of the auxiliary propeller body portion 61b. As the auxiliary motor 7b rotates, the auxiliary shaft 5b rotates. Due to this, the auxiliary propeller 6b fixed to the auxiliary shaft 5b rotates. Thus, it is also possible to adopt an inner rotor motor type motor as the auxiliary motor 7b. In the inner rotor motor, since the auxiliary shaft 5b axially protrudes from the auxiliary motor 7b and the auxiliary propeller 6b is fixed to the tip thereof, the auxiliary motor 7b can be fixed directly to the arm portion 122b. This allows the shape of the arm portion 122b to be simplified.

Other than this, there are features common to the first example embodiment.

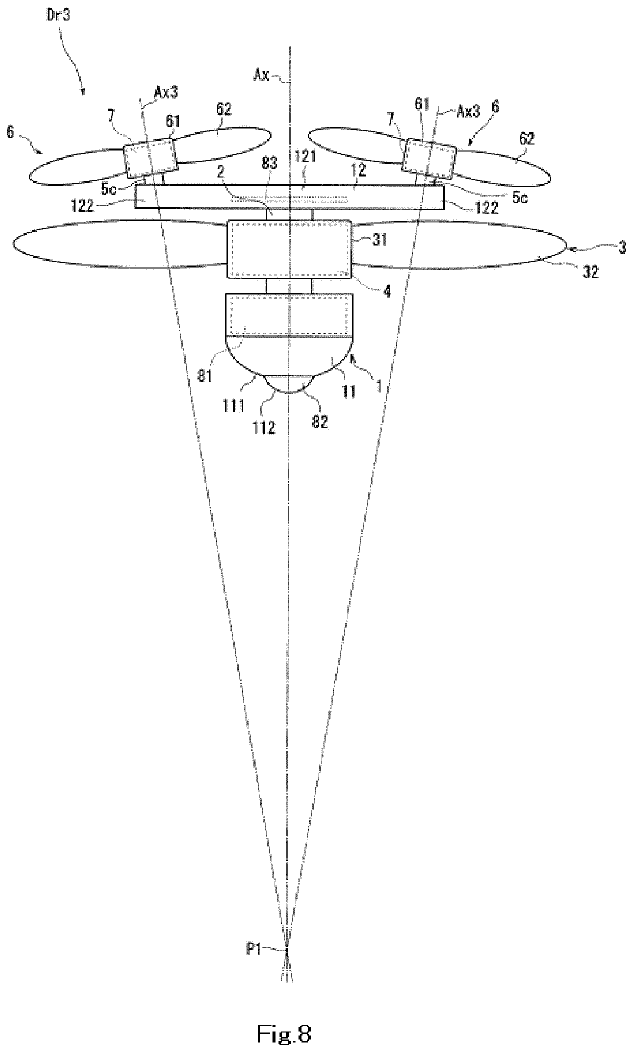

Yet another example of the unmanned aerial vehicle according to the present disclosure will be described with reference to the drawings. FIG. 8 is a schematic side view of yet another example of the unmanned aerial vehicle according to the present disclosure. An unmanned aerial vehicle Dr3 shown in FIG. 8 has the same configuration as that of the unmanned aerial vehicle Dr1 of the first example embodiment except that an auxiliary shaft 5c is different. For this reason, in the configuration of the unmanned aerial vehicle Dr3, the same components as those of the unmanned aerial vehicle Dr1 are given the same reference numerals and detailed descriptions thereof will be omitted.

As shown in FIG. 8, in the unmanned aerial vehicle Dr3, a central axis Ax3 of the auxiliary shaft 5c is inclined with respect to the central axis Ax of the unmanned aerial vehicle Dr3, that is, the central axis Ax of the main shaft 2. Specifically, the auxiliary shaft 5c approaches the central axis Ax as going axially downward. Extension lines in which the central axes Ax3 of the three auxiliary shafts 5c extend axially downward intersect with the central axis Ax at a point P1. In other words, the central axes Ax3 of the three auxiliary shafts 5c each approach the central axis Ax as going axially downward. All the angles of the central axes Ax3 of the three auxiliary shafts 5c formed with central axis Ax are equal.

That is, the lines in which the central axes Ax3 of the plurality of auxiliary shafts 5c extend intersect with the line in which the central axis Ax of the main shaft 2 extends at one point (point P1). Thus, the plurality of auxiliary propellers 6 can exert a radial force on the body portion 1 while maintaining the balance of forces acting on the body portion 1. This increases the operability of the unmanned aerial vehicle Dr3.

The operation of the unmanned aerial vehicle Dr3 will be described. The central axis Ax3 of the auxiliary shaft 5c is inclined with respect to the central axis Ax. The force acting on the body portion 1 by the rotation of the auxiliary propeller 6 connected to the auxiliary shaft 5c is in a direction along the central axis Ax3 of the auxiliary shaft 5c. Therefore, the force acting on the body portion 1 by the rotation of the auxiliary propeller 6 includes an axially downward force component and a radially outward force component. When the three auxiliary propellers 6 rotate at the same rotation speed, the radially outward force components from the respective auxiliary propellers 6 to the body portion 1 are equal. The force acting on the body portion 1 from the auxiliary propeller 6 is acting via the auxiliary shaft 5c. The three auxiliary shafts 5c are disposed at equal intervals in the circumferential direction, and any of the central axes Ax3 is inclined at the same angle with respect to the central axis Ax. Therefore, the radially outward force components of the forces acting on the body portion 1 from the three auxiliary propellers 6 cancel one another. That is, by rotating the three auxiliary propellers 6 at the same rotation speed, the unmanned aerial vehicle Dr3 can be brought into the hovering state.

On the other hand, since the three auxiliary shafts 5c are inclined, the attitude or the position of the unmanned aerial vehicle Dr3 can be greatly changed even if the change in the rotation speed of the auxiliary propeller 6 is small. For example, in a state where the unmanned aerial vehicle Dr3 is hovering, each of the auxiliary propellers 6 is rotated at a rotation speed at which the balance of the radial force components changes while balancing the axial force components, and hence a radial, i.e., horizontal movement is facilitated with the horizontal attitude being kept. Due to this, the control of the unmanned aerial vehicle Dr3 is easy, and the convenience of the unmanned aerial vehicle Dr3 is high. In the unmanned aerial vehicle Dr3 of the present example embodiment, the central axis Ax3 of the auxiliary shaft 5c approaches the central axis Ax as going axially downward, but, conversely, it may approach the central axis as going axially upward. In any case, the lines in which the central axes Ax3 of the three auxiliary shafts 5c extend may intersect with the line in which the central axis Ax of the main shaft 2 extends at one point (point P1).

Other than this, there are features common to the first example embodiment.

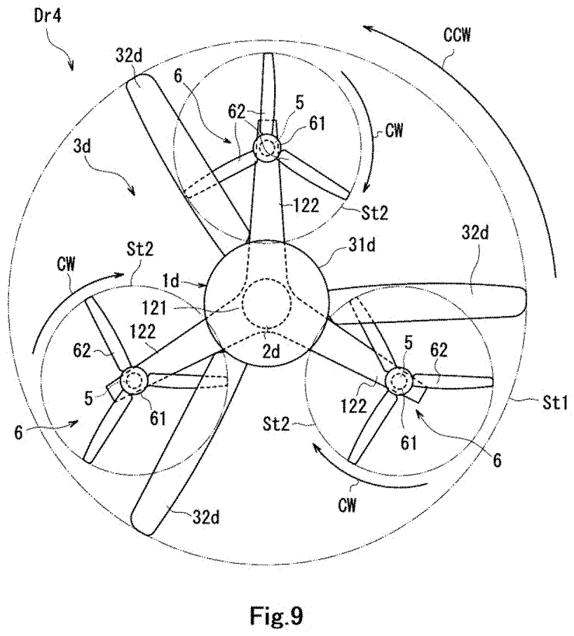

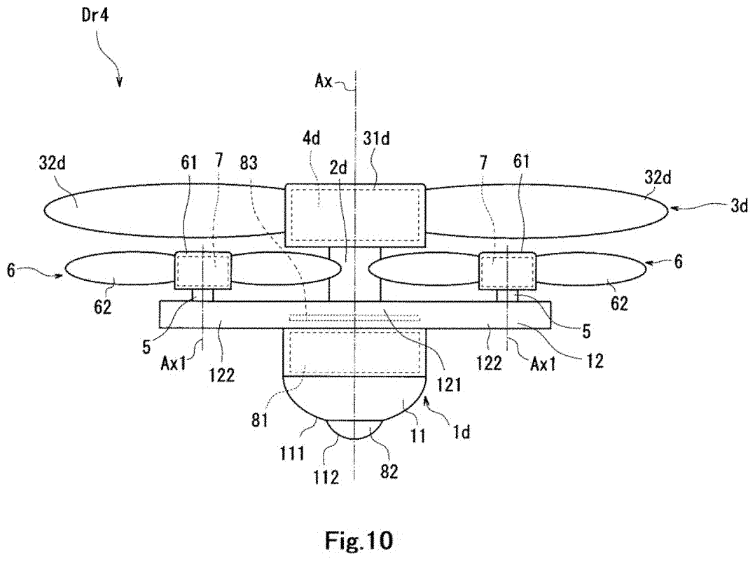

Yet another example of the unmanned aerial vehicle according to the present disclosure will be described with reference to the drawings. FIG. 9 is a schematic plan view of yet another example of the unmanned aerial vehicle according to the present disclosure. FIG. 10 is a schematic side view of the unmanned aerial vehicle shown in FIG. 9. An unmanned aerial vehicle Dr4 shown in FIGS. 9 and 10 has the same configuration as that of the unmanned aerial vehicle Dr1 of the first example embodiment except that a body portion 1d, a main shaft 2d, a main propeller 3d, and a main motor 4d are different. For this reason, in the configuration of the unmanned aerial vehicle Dr4, the same components as those of the unmanned aerial vehicle Dr1 are given the same reference numerals and detailed descriptions thereof will be omitted.

As shown in FIG. 10, the unmanned aerial vehicle Dr4 includes the body portion 1d, the main shaft 2d, the main propeller 3d, the main motor 4d, the auxiliary shaft 5, the auxiliary propeller 6, the auxiliary motor 7, the battery 81, the camera 82, and the circuit board 83. Although the lead wire is omitted in the unmanned aerial vehicle Dr4, the lead wire connects between the battery 81 and the circuit board 83 and between the circuit board 83 and the main motor 4d and the auxiliary motor 7.

The body portion 1d includes the main body portion 11 and the frame portion 12. In the body portion 1d, the axial upper surface of the main body portion 11 is in contact with the axial lower surface of the frame portion 12. The main body portion 11 and the frame portion 12 are integrally formed. Note that being integrally formed here includes being an integral molded body of a resin or the like and being integrally fixed with adhesion or the like. That is, the body portion 1d includes the main body portion 11 and the frame portion 12 that expands in a direction orthogonal to the central axis Ax of the main shaft 2d.

As shown in FIG. 10, the main shaft 2d has a cylindrical shape extending axially upward from the top surface of the frame body portion 121 of the frame portion 12. A lead wire that connects the circuit board 83 and the main motor 4d is wired in an internal space of the main shaft 2d. The central axis of the main shaft 2d coincides with the central axis Ax of the unmanned aerial vehicle Dr4. Therefore, the central axis of the main shaft 2d is described as the central axis Ax of the main shaft 2d.

The main shaft 2d extends more axially upward than the axial upper end of the auxiliary propeller 6. The main motor 4d is attached to the axial upper end of the main shaft 2d, and the main propeller 3d is connected to the main shaft 2d via the main motor 4d.

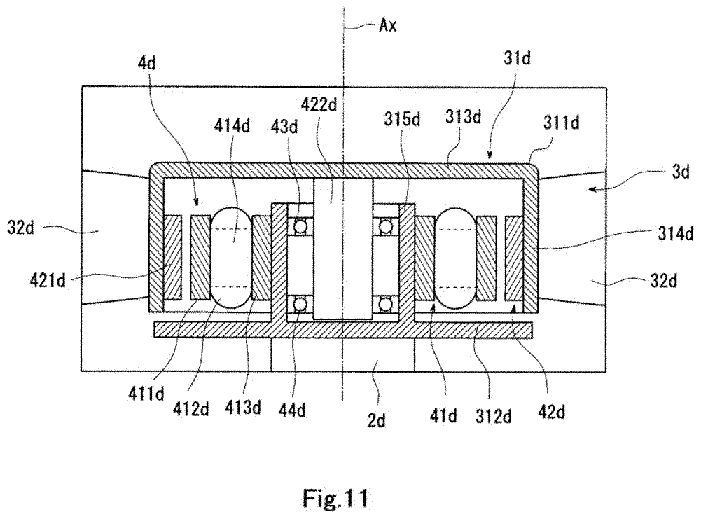

The main propeller 3d and the main motor 4d will be described with reference to the drawings. FIG. 11 is an enlarged sectional view of the main propeller 3d and the main motor 4d.

As shown in FIG. 9, the main propeller 3d includes a main propeller body portion 31d and three main blade portions 32d. As shown in FIG. 11, the main propeller body portion 31d includes an upper cover 311d and a lower cover 312d. The upper cover 311d has a lidded tubular shape. The upper cover 311d includes an annular upper lid portion 313d expanding in a direction orthogonal to the central axis Ax, and a cylindrical main propeller tubular portion 314d extending axially downward from a radial outer edge of the upper lid portion 313d. The axial upper surface of the rotor shaft 422d is fixed to the axial lower surface of the upper lid portion 313d. That is, the rotor shaft 422d extends axially downward from the radial center portion of the axial lower surface of the upper lid portion 313d. The upper lid portion 313d may be provided with an axially penetrating hole portion, and the upper end portion of the rotor shaft 422d may be fixed to the hole portion. The upper lid portion 313d and the rotor shaft 422d may be produced by integrally molding.

The lower cover 312d is in a disc form expanding in a direction orthogonal to the central axis Ax. A tubular bearing holding portion 315d extending axially upward is included in a radial center portion of the lower cover 312d. An upper bearing 43d and a lower bearing 44d of the main motor 4d are held by the bearing holding portion 315d. The axial lower surface of the main propeller tubular portion 314d axially faces the radial outer edge portion of the lower cover 312d.

An inner ring of the upper bearing 43d and an inner ring of the lower bearing 44d are fixed to the rotor shaft 422d at positions separated vertically in the axial direction.

The three main blade portions 32d extend radially outward from the radial outer surface of the main propeller tubular portion 314d. The three main blade portions 32d are fixed to the main propeller tubular portion 314d. That is, the main propeller 3d includes the propeller body portion 31d and the plurality of main blade portions 32d, which extend radially outward from the propeller body portion 31d and are circumferentially disposed. The main propeller tubular portion 314d and the three main blade portions 32d may be formed by integral molding. The three main blade portions 32d are disposed at equal intervals in the circumferential direction.

Next, the main motor 4d will be described. The main motor 4d is disposed in an axial upper end portion of the main shaft 2d. The main motor 4d is disposed inside the main propeller body portion 31d of the main propeller 3d. That is, the main propeller 3d radially faces a driver 4d. The driver 4d is housed inside the propeller body portion 31d. This configuration allows the axial length of the rotor shaft 422d to be shortened, and the transmission efficiency of the driving force to be enhanced.

The main motor 4d is an outer rotor type motor. The main motor 4d includes a stator 41d and a rotor 42d. The stator 41d includes a stator core 411d and a coil 412d. The stator core 411d is a laminate in which, for example, electromagnetic steel sheets are axially laminated. Note that the stator core 411d is not limited to a laminate in which electromagnetic steel sheets are laminated, and may be a single member such as a fired body of powder or a casting.

The stator core 411d includes an annular core back 413d and a plurality of teeth 414d. The bearing holding portion 315d is press-fitted into the central penetration portion of the annular core back 413d. Due to this, the stator core 411d is fixed to the bearing holding portion 315d. That is, the stator 41d is fixed to the lower cover 312d via the bearing holding portion 315d. The plurality of teeth 414d extend radially outward from the radial outer surface of the core back 413d, and are formed radially. The coil 412d is configured by winding a wire around each of the teeth 414d.

The rotor 42d includes a cylindrical rotor magnet 421d and a rotor shaft 422d. The rotor magnet 421d radially faces the teeth 414d. The rotor magnet 421d is fixed to a radial inner surface of the main propeller tubular portion 314d. In the rotor magnet 421d, N poles and S poles are alternately disposed in the circumferential direction. That is, the main motor 4d uses the main propeller tubular portion 314d as a rotor housing.

The upper bearing 43d and the lower bearing 44d are ball bearings. The upper bearing 43d and the lower bearing 44d include an outer ring, the inner ring, and a plurality of balls disposed between the outer ring and the inner ring. In the upper bearing 43d and the lower bearing 44d, the inner ring and the outer ring relatively rotate as the balls rotate. The outer ring of the upper bearing 43d is fixed to the bearing holding portion 315d. The outer ring of the lower bearing 44d is also fixed to the bearing holding portion 315d. Although fixation of the outer rings of the upper bearing 43d and the lower bearing 44d and the bearing holding portion 315d may include press-fit, it is not limited to this. The inner rings of the upper bearing 43d and the lower bearing 44d are fixed to axially separated portions of the rotor shaft 422d.

Although fixation of the outer rings of the upper bearing 43d and the lower bearing 44d and the rotor shaft 422d may include press-fit, it is not limited to this.

This causes the rotor shaft 422d to be rotatably supported by the bearing holding portion 315d via the upper bearing 43d and the lower bearing 44d. More specifically, the rotor shaft 422d and the upper cover 311d fixed to the rotor shaft 422d are rotatably supported relative to the lower cover 312d.

As shown in FIGS. 9 and 10, in the unmanned aerial vehicle Dr4, the main body portion 11 and the frame portion 12 are directly connected. Therefore, no member is interposed between the main body portion 11 and the frame portion 12, and hence a transmitted force is less likely to be attenuated. For example, when controlling the rotation speed of the auxiliary propeller 6, the responsiveness of change of the attitude of the unmanned aerial vehicle Dr4 and change of the movement direction of the unmanned aerial vehicle Dr4 is high. Therefore, the operability of the unmanned aerial vehicle Dr4 is increased. The main propeller 3d, the main motor 4d, the auxiliary propeller 6, and the auxiliary motor 7 are all positioned axially above the frame portion 12. That is, the frame portion 12 is disposed axially between the main body portion 11 and the main propeller 3d and the plurality of auxiliary propellers 6. Thus, the main propeller 3d and the auxiliary propeller 6 are on the same side (axially upper side) with respect to the body portion 1. Therefore, at the time of maintenance such as adjustment and repair, it is sufficient to only work on the unmanned aerial vehicle Dr4 from axially above, and the workability is high.

Other than this, there are features common to the first example embodiment.

An actual example of the unmanned aerial vehicle Dr4 of the present example embodiment will be described. An example of the unmanned aerial vehicle Dr4 of the present example embodiment is taken as Example 3. The unmanned aerial vehicle Dr4 of Example 3 is capable of generating a lift of 50 g. The unmanned aerial vehicle Dr4 of Example 3 uses the main propeller 3d having an outermost diameter, that is, the outer diameter of the locus St1 of the radially outer end of the main blade portion 32d of 120 mm. The unmanned aerial vehicle Dr4 of Example 3 also uses the three auxiliary propellers 6 each having an outermost diameter, that is, the outer diameter of the locus St2 of the radially outer end of the auxiliary blade portion 62 of 50 mm. The main motor 4d and the auxiliary motor 7 are outer rotor motors.

The weight of the body portion 1d and the like are 20 g. The weight of the main propeller 3d is 3 g and the weight of the main motor 4d is 4 g, thus the total of 7 g. The weight of the auxiliary propeller 6 is 1 g and the weight of the auxiliary motor 7 is 1.5 g, and the total of the three auxiliary propellers 6 and auxiliary motor 7 is 7.5 g. The weight of the battery 81 is 8 g, the weight of the camera 82 is 3 g, and the weight of the circuit board 83 is 1 g. Therefore, the total weight of Example 3 is 46.5 g. With this configuration, the unmanned aerial vehicle Dr4 of Example 3 can fly.

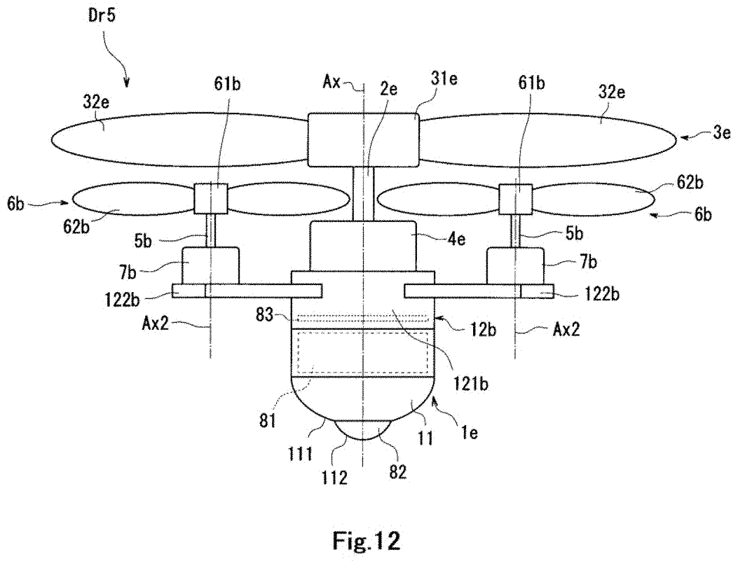

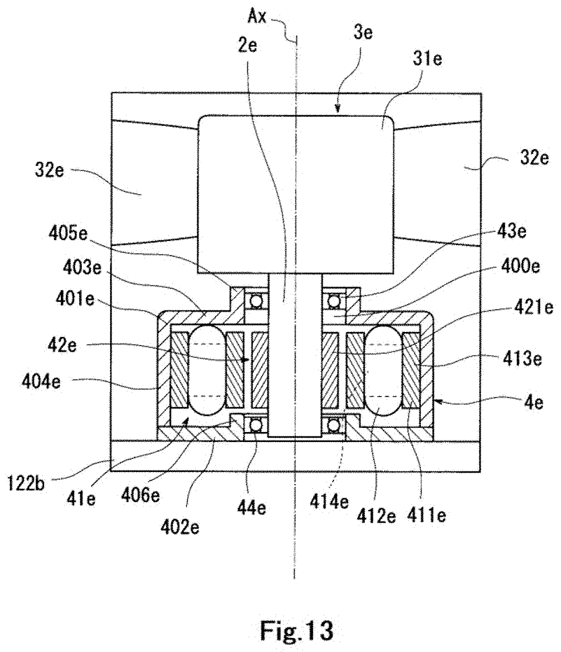

Yet another example of the unmanned aerial vehicle according to the present disclosure will be described with reference to the drawings. FIG. 12 is a schematic side view of yet another example of the unmanned aerial vehicle according to the present disclosure. FIG. 13 is an enlarged sectional view of the main propeller and the main motor of the unmanned aerial vehicle shown in FIG. 12. An unmanned aerial vehicle Dr5 shown in FIG. 12 has the same configuration as that of the unmanned aerial vehicle Dr2 of the second example embodiment except that a body portion le, a main shaft 2e, a main propeller 3e, and a main motor 4e are different from the body portion 1b, the main shaft 2, the main propeller 3, and the main motor 4. For this reason, in the configuration of the unmanned aerial vehicle Dr5, the same components as those of the unmanned aerial vehicle Dr2 are given the same reference numerals and detailed descriptions thereof will be omitted.

As shown in FIG. 13, an axial lower surface of the frame portion 12b of the body portion le of the unmanned aerial vehicle Dr5 is in contact with an axial upper surface of the main body portion 11. That is, the frame portion 12b and the main body portion 11 are directly connected. The main body portion 11 and the frame portion 12b may be integrally formed or may be separable. In a case of being separable, it may be configured such that, when the main body portion 11 and the frame portion 12b are separated, the battery 81 disposed inside the main body portion 11 and the circuit board 83 disposed in the frame portion 12b are exposed to the outside. As a fixing method for the main body portion 11 and the frame portion 12b, it is possible to adopt a method in which, for example, an internal thread is formed on one side and an external thread is formed on the other side and the external thread is screwed on the female thread. Also, other methods may be adopted.

The main motor 4e is an inner rotor type motor. The main motor 4e is fixed to an axial upper surface of the frame body portion 121b. The main motor 4b includes an upper cover 401e, a base portion 402e, a stator 41e, a rotor 42e, an upper bearing 43e, and a lower bearing 44e.

The upper cover 401e has a lidded tubular shape. The upper cover 401e includes an upper lid portion 403e, a main motor tubular portion 404e, and an upper bearing holding portion 405e. The upper lid portion 403e has an annular shape expanding in a direction orthogonal to the central axis Ax, and has a through hole 400e at the center. The main motor tubular portion 404e extends axially downward from a radial outer edge portion of the upper lid portion 403e. The upper bearing holding portion 405e has a tubular shape extending axially upward from the side edge portion of the through hole 400e of the upper lid portion 403e. The center of the upper bearing holding portion 405e coincides with the central axis Ax.

The base portion 402e has an annular shape expanding in a direction orthogonal to the central axis Ax. The base portion 402e includes a lower bearing holding portion 406e. The lower bearing holding portion 406e has a cylindrical shape, and is disposed at the radial center portion of the base portion 402e. The center of the lower bearing holding portion 406e overlaps the central axis Ax.

The outer ring of the upper bearing 43e is fixed to a radial inner surface of the upper bearing holding portion 405e. Thus, the center of the inner ring of the upper bearing 43e overlaps the central axis Ax. The outer ring of the lower bearing 44e is fixed to a radial inner surface of the lower bearing holding portion 406e. Thus, the center of the inner ring of the lower bearing 44e overlaps the central axis Ax. The main shaft 2e is fixed to the inner rings of the upper bearing 43e and the lower bearing 44e by press-fitting. This causes the main shaft 2e to be rotatably supported by the upper cover 401e and the base portion 402e. The main shaft 2e protrudes outward axially upward from the through hole at the radial center of the upper lid portion 403e of the upper cover 401e. The main shaft 2e extends axially upward from the arm portion 122b, that is, the body portion le, via the main motor 4e.

The stator 41e includes a stator core 411e and a coil 412e. The stator core 411e includes an annular core back 413e and a plurality of teeth 414e. The annular core back 413e is fixed to a radial inner surface of the main motor tubular portion 404e. The plurality of teeth 414e extend radially inward from the annular core back 413e. The coil 412e is configured by winding a wire around each of the teeth 414e.

The rotor 42e includes a rotor magnet 421e. The rotor magnet 421e is cylindrical and fixed to a radial outer surface of the main shaft 2e. The rotor magnet 421e radially faces the teeth 414e. The main shaft 2e is press-fitted into the upper bearing 43e and the lower bearing 44e, and the rotor 42e is rotatable with respect to the upper cover 401e and the base portion 402e. The main shaft 2e rotates around the central axis Ax by supplying a current to the coil 412e.

The main propeller 3e is fixed to an upper end portion of the main shaft 2e. The main propeller 3e includes a main propeller body portion 31e and a main blade portion 32e. The main propeller body portion 31e is columnar, and the center of the main propeller body portion 31e overlap the central axis Ax. The main blade portion 32e extends radially outward from the radial outer surface of the main propeller body portion 31e. As the main motor 4e rotates, the main shaft 2e rotates. Due to this, the main propeller 3e fixed to the main shaft 2e rotates. Thus, it is also possible to adopt an inner rotor motor type motor as the main motor 4e. In the inner rotor motor, since the main shaft 2e axially protrudes from the main motor 4e and the main propeller 3e is fixed to the tip thereof, the main motor 4e can be fixed directly to the frame body portion 121b. In addition, it is easy to use a general-purpose product as the main motor 4e, the degree of freedom in design is increased, and the maintainability is high.

In the unmanned aerial vehicle Dr5 of the present example embodiment, the main motor 4e and the three auxiliary motors 7b are fixed to the frame portion 12. That is, the main motor 4e that drives the main propeller 3e and the auxiliary driver 7b that drives the auxiliary propeller 6b are disposed in the frame portion 12. Since the motor is fixed directly to the frame portion 12, fixing of the motor is easy. Moreover, the part to which the motor of the flame portion 12 is attached may be a plane, and the workability is high. In addition, it is possible to position the center of gravity of the unmanned aerial vehicle Dr5 near the body portion, and it is possible to stably fly the unmanned aerial vehicle Dr5.

Other than this, there are features common to the second example embodiment.

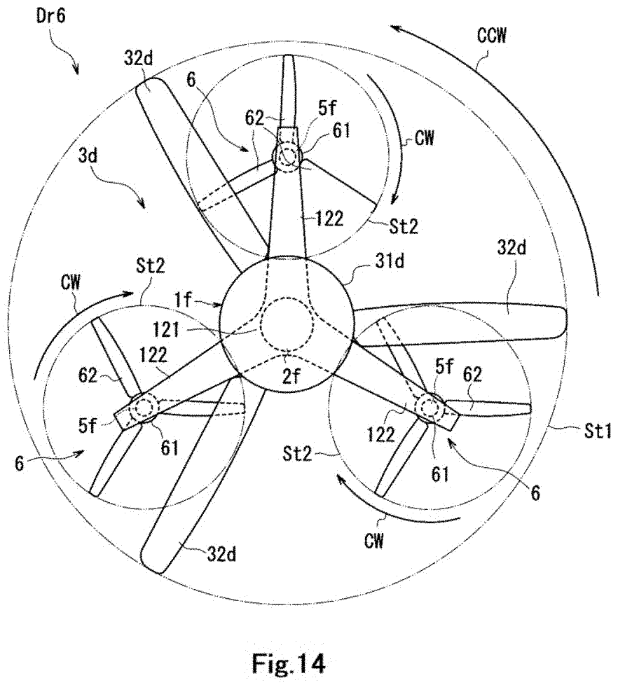

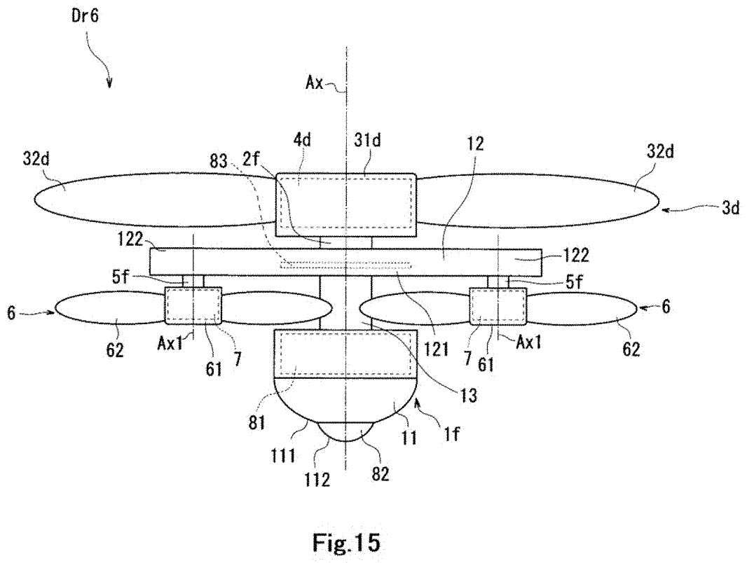

Yet another example of the unmanned aerial vehicle according to the present disclosure will be described with reference to the drawings. FIG. 14 is a plan view of yet another example of the unmanned aerial vehicle according to the present disclosure. FIG. 15 is a schematic side view of the unmanned aerial vehicle shown in FIG. 14. An unmanned aerial vehicle Dr6 shown in FIGS. 14 and 15 differs from the unmanned aerial vehicle Dr4 of the fourth example embodiment in that an auxiliary shaft 5f extends axially downward. Along with this, the configurations of a body portion if and a main shaft 2f are slightly different, but the configurations of the others are the same as those of the unmanned aerial vehicle Dr4. For this reason, substantially the same parts will be given the same reference numerals and detailed descriptions of the same parts will be omitted.

As shown in FIG. 15, the unmanned aerial vehicle Dr6 includes the body portion 1f, the main shaft 2f, the main propeller 3d, the main motor 4d, the auxiliary shaft 5f, the auxiliary propeller 6, the auxiliary motor 7, the battery 81, the camera 82, and the circuit board 83. Although the lead wire is omitted in the unmanned aerial vehicle Dr4, the lead wire connects between the battery 81 and the circuit board 83 and between the circuit board 83 and the main motor 4d and the auxiliary motor 7.

The body portion if includes the main body portion 11 and the frame portion 12. The main body portion 11 and the frame portion 12 are the same as the main body portion 11 and the frame portion 12 of the unmanned aerial vehicle Dr1 of the first example embodiment, and detailed description will be omitted. In the body portion 1f, the main body portion 11 and the frame portion 12 are connected via a tubular portion 13. The center of the tubular portion 13 overlaps the central axis Ax. Inside the tubular portion 13, a lead wire connecting the battery 81 and the circuit board 83 is housed. In the body portion 1f, since the main body portion 11 and the frame portion 12 interfere with the auxiliary propeller 6, the main body portion 11 and the frame portion 12 are axially separated from each other and coupled via the tubular portion 13. However, if not interfering with the auxiliary propeller 6, the main body portion 11 and the frame portion 12 may be directly fixed, as in the body portion 1d or the like.

The main shaft 2f is a cylindrical body extending axially upward from an axial upper surface of the frame body portion 121 of the frame portion 12. The center of the main shaft 2f coincides with the central axis Ax. The main motor 4d is connected to and the main propeller 3d connected via the main motor 4d to an axial upper end of the main shaft 2f.

In the unmanned aerial vehicle Dr6, the auxiliary shaft 5f extends axially downward from the arm portion 122 of the frame portion 12. And the auxiliary motor 7 is attached to the axial lower end of auxiliary shafts 5f. The auxiliary propeller 6 is connected to the axial lower end of the auxiliary shaft 5 via the auxiliary motor 7.

That is, in the unmanned aerial vehicle Dr6, the main propeller 3b is disposed axially above the frame portion 12 and the auxiliary propeller 6 is disposed axially below the frame portion 12. With such configuration, the axial directions of the main motor 4b and the auxiliary motor 7 are opposite to each other. Therefore, even if the main motor 4b and the auxiliary motor 7 are rotated in the same direction as viewed from the axial upper cover side, the torque acting on the unmanned aerial vehicle Dr6 can be opposite to each other. This allows the control of the main motor 4b and the three auxiliary motors 7 to be simplified.

In addition, since the rotor shaft of each of the main motor 4b and the auxiliary motor 7 can be shortened, the rotation accuracy can be enhanced. This can increase the operability of the unmanned aerial vehicle Dr6.

In the unmanned aerial vehicle Dr6, the plurality of auxiliary propellers 6 are disposed axially between the main body portion 11 and the frame portion 12. The main driver 4d that drives the main propeller 3d is disposed on the main propeller 3d side, which is one side of the frame portion 12. The plurality of auxiliary drivers 7 are disposed on the plurality of auxiliary propellers 6 side, which is the other side of the frame portion 12. The body portion if includes the tubular portion 13 extending axially at the center of a pitch circle of the plurality of auxiliary drivers 7. The tubular portion 13 supports the frame portion 12. This can shorten the length of the rotor shaft. This can increase the rotation accuracy of the main propeller 3d and the auxiliary propeller 7, and can reduce the noise of the rotation of the main propeller 3d and the auxiliary propeller 7.

Other than this, there are features common to the fourth example embodiment.

An actual example of the unmanned aerial vehicle Dr6 of the present example embodiment will be described. An example of the unmanned aerial vehicle Dr6 of the present example embodiment is taken as Example 4. The unmanned aerial vehicle Dr6 of Example 4 is capable of generating a lift of 50 g. The unmanned aerial vehicle Dr6 of Example 4 uses the main propeller 3d having an outermost diameter, that is, the outer diameter of the locus St1 of the radially outer end of the main blade portion 32d of 120 mm. The unmanned aerial vehicle Dr6 of Example 4 also uses the three auxiliary propellers 6 each having an outermost diameter, that is, the outer diameter of the locus St2 of the radially outer end of the auxiliary blade portion 62 of 50 mm. The main motor 4 and the auxiliary motor 7 are outer rotor motors.

The weight of the body portion if and the like are 20 g. The weight of the main propeller 3d is 3 g and the weight of the main motor 4d is 4 g, thus the total of 7 g. The weight of the auxiliary propeller 6 is 1 g and the weight of the auxiliary motor 7 is 1.5 g, and the total of the three auxiliary propellers 6 and auxiliary motor 7 is 7.5 g. The weight of the battery 81 is 8 g, the weight of the camera 82 is 3 g, and the weight of the circuit board 83 is 1 g. Therefore, the total weight of Example 4 is 46.5 g. With this configuration, the unmanned aerial vehicle Dr6 of Example 4 can fly.

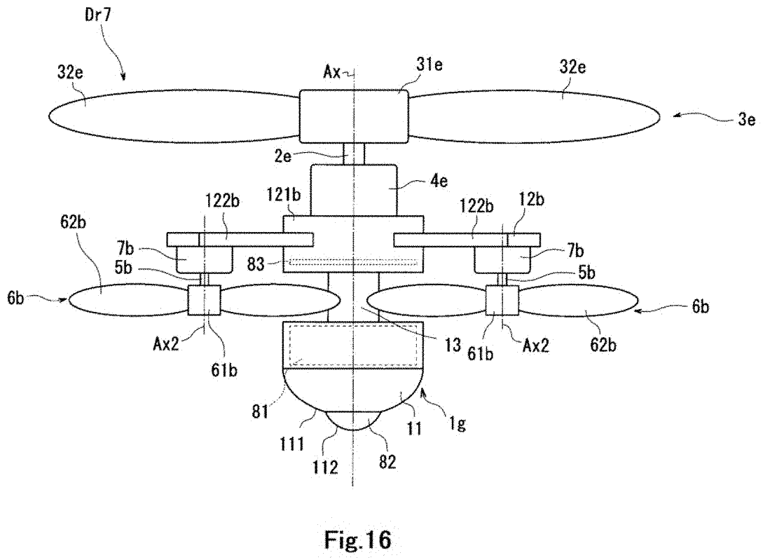

Yet another example of the unmanned aerial vehicle according to the present disclosure will be described with reference to the drawings. FIG. 16 is a schematic side view of yet another example of the unmanned aerial vehicle according to the present disclosure. An unmanned aerial vehicle Dr7 shown in FIG. 16 has the same configuration as that of the unmanned aerial vehicle Dr6 shown in FIG. 6 except the use of a body portion 1g, the main propeller 3e, the main motor 4e, the auxiliary propeller 6b, and the auxiliary motor 7b. For this reason, in the unmanned aerial vehicle Dr7 shown in FIG. 16, substantially the same parts as those of the unmanned aerial vehicle Dr6 will be given the same reference numerals and detailed descriptions of the same parts will be omitted.

As shown in FIG. 16, the unmanned aerial vehicle Dr7 includes the body portion 11 and the frame portion 12b. The axial upper surface of the body portion 11 and the axial lower surface of the frame portion 12b are coupled via the tubular portion 13. The tubular portion 13 is an axially extending cylindrical body that includes an internal space. In the internal space, a lead wire (not illustrated) connecting the battery 81 and the circuit board 83 is disposed.

As shown in FIG. 16, in the unmanned aerial vehicle Dr7, the main motor 4e, which is an inner rotor type motor, can be used by using the frame portion 12b. It is also possible to directly fix the auxiliary motor 7b, which is an inner rotor type motor, to the axial lower surface of the arm portion 122b. Since the inner rotor type motor has a motor and a propeller that are separate from each other, it is possible to use a general-purpose motor. Moreover, since it is less prone to a shape or other restrictions, the degree of freedom in design can be increased.

Other than this, there are features common to the sixth example embodiment.

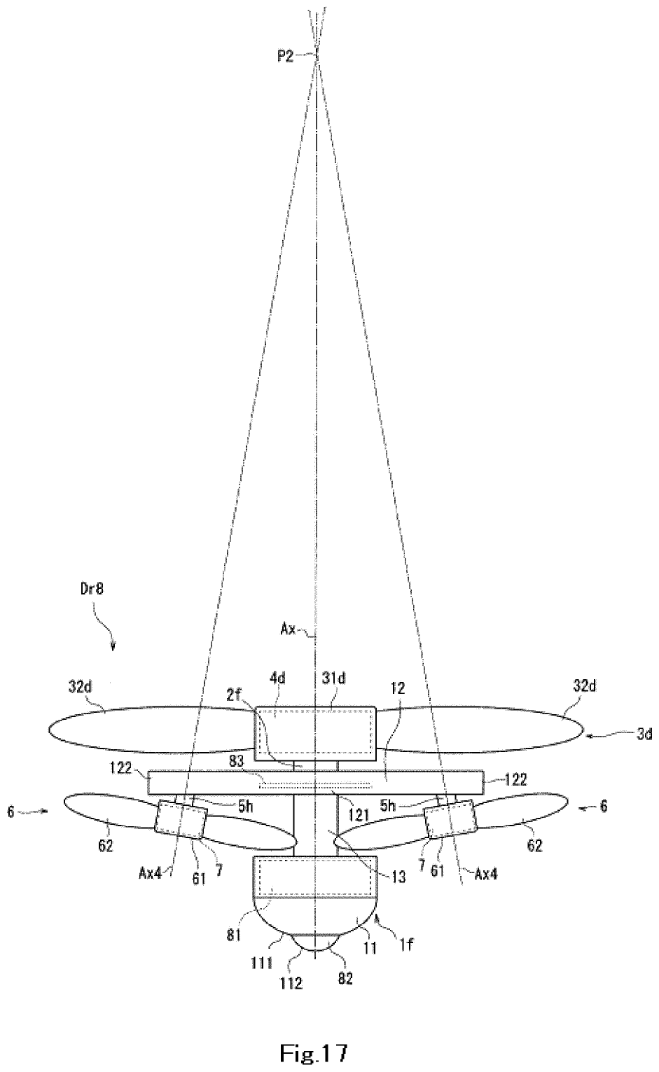

Yet another example of the unmanned aerial vehicle according to the present disclosure will be described with reference to the drawings. FIG. 17 is a schematic side view of yet another example of the unmanned aerial vehicle according to the present disclosure. An unmanned aerial vehicle Dr8 shown in FIG. 17 has the same configuration as that of the unmanned aerial vehicle Dr6 of the sixth example embodiment except that an auxiliary shaft 5h is different. For this reason, in the configuration of the unmanned aerial vehicle Dr8, the same components as those of the unmanned aerial vehicle Dr6 are given the same reference numerals and detailed descriptions thereof will be omitted.

As shown in FIG. 17, in the unmanned aerial vehicle Dr8, an central axis Ax4 of the auxiliary shaft 5h is inclined with respect to the central axis Ax of the unmanned aerial vehicle Dr8, that is, the central axis Ax of the main shaft 2f. Specifically, the auxiliary shaft 5h approaches the central axis Ax as going axially upward. Extension lines in which the central axes Ax4 of the three auxiliary shafts 5h extend axially upward intersect with the central axis Ax at a point P2. In other words, the central axes Ax4 of the three auxiliary shafts 5h each approach the central axis Ax as going axially upward. All the angles of the central axes Ax4 of the three auxiliary shafts 5h formed with central axis Ax are equal.

That is, the lines in which the central axes Ax4 of the plurality of auxiliary shafts 5h extend intersect with the line in which the central axis Ax of the main shaft 2f extends at one point. Thus, the plurality of auxiliary propellers 6 can exert a radial force on the body portion 1 while maintaining the balance of forces acting on the body portion 1. This increases the operability of the unmanned aerial vehicle Dr8.

Thus, by the auxiliary shaft 5h being inclined, the air flow generated by the rotation of the auxiliary propeller 6 is directed axially downward and radially outward. Therefore, the air flow generated by the auxiliary propeller 6 is less likely to be disturbed, and as a result, the drive efficiency of the unmanned aerial vehicle Dr8 is increased. Furthermore, since the air flow is unlikely to be disturbed, it is possible to perform a responsive attitude change and movement when the rotation speed of the auxiliary propeller 6 is changed. This can increase the operability. In the unmanned aerial vehicle Dr8 of the present example embodiment, the central axis Ax4 of the auxiliary shaft 5h approaches the central axis Ax as going axially upward, but, conversely, it may approach the central axis Ax as going axially downward. In any case, the lines in which the central axes Ax4 of the three auxiliary shafts 5h extend may intersect with the line in which the central axis Ax of the main shaft 2f extends at one point (point P2).

While the example embodiments of the present disclosure have been described above, the example embodiments can be modified and combined in various ways within the scope of the present disclosure.

The present disclosure can be used for unmanned aerial vehicles used for sound recording, photographing, and the like.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-16. (canceled)

17. An unmanned aerial vehicle, comprising:
a body;
a main shaft extending axially from the body;
a main propeller connected to the main shaft;
a plurality of auxiliary shafts extending axially from the body;
a plurality of auxiliary propellers connected to the plurality of auxiliary shafts respectively; and
a plurality of drivers that drive the main propeller and the plurality of auxiliary propellers; wherein
a circle drawn by a tip of the main propeller and a circle drawn by tips of each of the plurality of auxiliary propellers axially overlap at least partially;
a rotational direction of the plurality of auxiliary propellers is opposite to a rotational direction of the main propeller, when viewed from one axial side of the main shaft; and
a torque acting on the body from the main propeller when the body is hovering in an air is equal or substantially equal to a sum of torque acting on the body from the plurality of auxiliary propellers.

18. The unmanned aerial vehicle according to claim 17, wherein at least one of the main propeller and the plurality of auxiliary propellers radially face the driver.

19. The unmanned aerial vehicle according to claim 18, wherein
at least one of the main propeller and the plurality of auxiliary propellers each include:
a propeller body; and
a plurality of main blades, which extend radially outward from the propeller body and are circumferentially disposed; and
the driver is housed inside the propeller body.

20. The unmanned aerial vehicle according to claim 17, wherein
each of the plurality of auxiliary propellers is drivable at a rotation speed different from that of other auxiliary propellers; and
a torque acting on the body from the main propeller when the body is moving in an air is different from a sum of torque acting on the body from the plurality of auxiliary propellers.

21. The unmanned aerial vehicle according to claim 17, wherein central axes of the plurality of auxiliary shafts are parallel or substantially parallel to a central axis of the main shaft.

22. The unmanned aerial vehicle according to claim 17, wherein lines in which central axes of the plurality of auxiliary shafts extend intersect with a line in which a central axis of the main shaft extends at one point.

23. The unmanned aerial vehicle according to claim 17, wherein the body includes:
a main body; and
a frame expanding in a direction perpendicular or substantially perpendicular to a central axis of the main shaft;
the frame is disposed axially between the main body and any one of the main propeller and the plurality of auxiliary propellers; and
a plurality of auxiliary drivers that drive the plurality of auxiliary propellers are connected to the frame.

24. The unmanned aerial vehicle according to claim 23, wherein a main driver that drives the main propeller and the plurality of auxiliary drivers are disposed in the frame.

25. The unmanned aerial vehicle according to claim 23, wherein the frame includes:
a frame body; and
a plurality of arms extending radially from the frame body; and
the plurality of auxiliary drivers are connected to the respective arms.

26. The unmanned aerial vehicle according to claim 23, wherein the main body includes a battery.

27. The unmanned aerial vehicle according to claim 23, wherein the main body includes a camera.

28. The unmanned aerial vehicle according to claim 17, wherein the body includes:
a main body; and
a frame expanding in a direction perpendicular or substantially perpendicular to a central axis of the main shaft;
the frame is disposed axially between the main propeller and the plurality of auxiliary propellers; and
a plurality of auxiliary drivers that drive the plurality of auxiliary propellers among the plurality of drivers are connected to the frame.

29. The unmanned aerial vehicle according to claim 28, wherein
the main propeller is disposed axially between the main body and the frame;
the main driver that drives the main propeller is disposed axially between the main body and the frame;
the plurality of auxiliary drivers are disposed in the frame;
the main body and the frame are connected via a hollow shaft; and
a connection wire that electrically connects the main driver and at least one of the plurality of auxiliary drivers is disposed inside the hollow shaft.

30. The unmanned aerial vehicle according to claim 28, wherein
the plurality of auxiliary propellers are disposed axially between the main body and the frame;
the main driver that drives the main propeller is disposed on the main propeller side, which is one side of the frame;
the plurality of auxiliary drivers are disposed on the plurality of auxiliary propellers side, which is another side of the frame;
the body further includes a tubular portion extending axially at a center of a pitch circle of the plurality of auxiliary drivers; and
the tubular portion supports the frame.

31. The unmanned aerial vehicle according to claim 28, wherein the frame includes:
a frame body; and
a plurality of arms extending radially from the frame body; and
the plurality of auxiliary drivers are connected to the respective arms.

32. The unmanned aerial vehicle according to claim 28, wherein the main body includes a battery.

33. The unmanned aerial vehicle according to claim 28, wherein the main body includes a camera.

34. The unmanned aerial vehicle according to claim 17, wherein the body includes a battery.

35. The unmanned aerial vehicle according to claim 17, wherein the body includes a camera.
